(19) United States
(12) Patent Application Publication
(10) Pub. No.: US 2016/0152493 A1
(43) Pub. Date: Jun. 2, 2016

(54) WASTEWATER TREATMENT SYSTEM AND METHOD

(71) Applicants: DAVID SZYKOWNY, TOOELE, UT (US); JAMIE HESTEKIN, FAYETTEVILLE, AR (US); BRIGITTE RODGERS, FAYETTEVILLE, AR (US); DMYTRO DEMYDOV, FAYETTEVILLE, AR (US); JOHN SCHMELZLE, ROGERS, AR (US)

(72) Inventors: DAVID SZYKOWNY, TOOELE, UT (US); JAMIE HESTEKIN, FAYETTEVILLE, AR (US); BRIGITTE RODGERS, FAYETTEVILLE, AR (US); DMYTRO DEMYDOV, FAYETTEVILLE, AR (US); JOHN SCHMELZLE, ROGERS, AR (US)

(21) Appl. No.: 14/954,627

(22) Filed: Nov. 30, 2015

Related U.S. Application Data
(60) Provisional application No. 62/085,359, filed on Nov. 28, 2014.

(51) Int. Cl. C02F 1/469; C02F 1/24; C02F 1/42; B01D 29/56; C02F 1/40

(52) U.S. Cl. CPC C02F 1/4695; B01D 29/56; C02F 1/40; C02F 1/42; C02F 1/24; C02F 1/4693; C02F 2101/32

(57) ABSTRACT

Wastewater treatment systems and methods that include a first sub-system that removes suspended solids and free/soluble oil from wastewater and a second sub-system that removes targeted ions or elements from wastewater. Wastewater treatment systems and methods that include an EDI system, including one or more ion exchange wafer configured to selectively remove a specifically targeted ion to a predetermined maximum level of concentration.

### CROSS-REFERENCE TO RELATED APPLICATIONS

This application claims priority to United States provisional patent application Ser. No. 62/085,359, filed Nov. 28, 2014, the entire disclosure of which is incorporated herein by reference.

### FIELD

The present inventive concept relates generally to wastewater treatment systems and methods. More particularly, the present inventive concept is concerned with systems and related methods to treat wastewater in multiple steps to target specific impurities for removal.

### BACKGROUND

Various methods of treating wastewater are known in the art. The removal of contaminants and impurities from wastewater provides many benefits.

Wafer Electrodeionization has been developed for use in the recovery of high product ions and organics. It has also been for use in ultra-pure water creation for commercial electronics. The large growth of hydraulic fracturing in the US has resulted in increased water usage in the industry, resulting in water scarcity in rural areas where fracturing occurs.

Increasing energy demands have driven novel technologies to the forefront of the petroleum industry. For example, hydraulic fracturing has expanded tremendously over the past five years with concentrated efforts in Pennsylvania, Texas, and North Dakota. The new source of natural gas and oil has been met with challenges, specifically large water requirements for the fracturing process (“fracking”). Consumption of water at these fracking sites can be as high as 1 million gallons a day or 10-20 million gallons of water per fracking site. This need for water can be difficult to meet in areas where water is scarce; resulting in large amounts of resources spent on transporting water to these sites. To mitigate this issue, the recycle of process water has recently been considered by fracking companies. The inventive concept includes the development of a wafer Electrodeionization module specifically designed to handle the high salt solutions of fracking process water and output usable water for subsequent fracking or treated to a level suitable for discharge to the atmosphere. Implementation of this inventive concept will lead to significantly reduced water demand in the fracking industry, resulting in lower costs and energy inputs for the overall process.

In another example, the inventive concept relates to the recovery and re-use of oil refinery waste water as plant raw water make-up. Oil and Gas wells often naturally produce water which is extracted along with hydrocarbons. This water often carries high levels of contaminates which must either be disposed of or treated in order to make it suitable for reuse or discharge to the atmosphere. Some examples of these wastewater contaminants include calcium, sodium, nitrate, chloride, selenium, mercury, boron, sulfate, magnesium, potassium, and others.

Prior art wastewater treatment systems and methods have been described in the following references, each of which is incorporated by reference in its entirety.

Arora, M. B., Hestekin, J. A., Snyder, S. W., St. Martin, E. J., Lin, Y. J., Donnelly, M. I., & Sanville Millard, C., (2007) The Separative Bioreactor: A Continuous Separation Process for the Simultaneous Production and Direct Capture of Organic Acids, Separation Science and Technology, 42:11, 2519-2538, DOI: 10.1080/01496390701477238

Alvarado, L., & Chen, A. (2014). Electrodeionization Principles, strategies and applications.pdf. Electrochimica Acta, 132, 583-597.

H., S. (2010). Electrodialysis, a mature technology with a multitude of new applications. Special Issue to Honour the Previous Editor Miriam Balaban, 264(3), 268-288. doi:10.1016/j.desal.2010.04.069

Ho, T., Kurup, A., Davis, T., & Hestekin, J. (2010). Wafer Chemistry and Properties for Ion Removal by Wafer Enhanced Electrodeionization. Separation Science and Technology, 45(4), 433-446. doi:10.1080/01496390903526709

Huang, C., Xu, T., Zhang, Y., Xue, Y., & Chen, G. (2007). Application of electrodialysis to the production of organic acids: State-of-the-art and recent developments. Journal of Membrane Science, 288(1-2), 1-12. doi:10.1016/j.memsci.2006.11.026

Kurup, A. S., Ho, T., & Hestekin, J. A. (2009). Simulation and Optimal Design of Electrodeionization Process: Separation of Multicomponent Electrolyte Solution. Industrial & Engineering Chemistry Research, 48(20), 9268-9277. doi:10.1021/ie801906d

Simplified electrodeionization technology reduces operating costs. (2010). Chemical Engineering, 117(8), 9. Retrieved from http://0-search. ebscohost.com.library.uark.edu/login. aspx?direct=true&db=a9h&AN=53013195&site=ehost-live

Prior art wastewater treatment systems and methods have various shortcomings. For example, prior art wastewater treatment systems and methods cannot remove high total dissolved solids and maintain high water recoveries. By way of another example, in refinery and hydraulic fracturing operations selective separation of specific ions is quite important. In hydraulic fracturing, calcium concentration needs to be at less than 2,000 ppm; sodium needs to be at less than 30,000 ppm. Thus, selective separation of ions to achieve specific levels of maximum concentration is important. Prior art wastewater treatment systems are unable to achieve separation of specifically selected targeted ions, at the levels desired. These and other weaknesses of the prior art wastewater treatment systems are addressed by the present inventive concept.

The present inventive concept is described below in the context of a preferred embodiment where the source/feed wastewater to be treated is a byproduct of the fracking process commonly encountered in the oil and gas industry. One skilled in the art will readily recognize that the wastewater treatment system and method described herein can be used in many other industries and contexts.

### SUMMARY

In some embodiments, the present inventive concept is a system for treating wastewater. The system includes two or more sub-systems for treating wastewater. The first sub-system removes suspended solids and free/soluble oil. The second (and subsequent) sub-system(s) removes specifically targeted ions and/or elements to reduce them to desirable levels.

In some embodiments, the present inventive concept is a method of treating wastewater. The method includes removing suspended solids and free/soluble oil from a source of wastewater and removing specifically targeted ions and/or elements to predetermined maximum levels.

In some embodiments, the present inventive concept is a wastewater treatment system for selectively removing specifically targeted ions to predetermined maximum levels of concentration. In some such embodiments, the specifically targeted ions include calcium, nitrate, selenium, mercury, boron, sodium, and/or chloride.

In some embodiments, the present inventive concept is a wastewater treatment method for selectively removing specifically targeted ions to predetermined maximum levels of concentration. In some such embodiments, the specifically targeted ions include calcium, nitrate, selenium, mercury, boron, sodium, and/or chloride.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention are set forth in the following description and are shown in the drawings, exhibits and/or appendixes.

FIG. 1 shows an exemplary embodiment of a system of the present inventive concept.

FIG. 2 shows an exemplary embodiment of a method of the present inventive concept.

FIG. 3 shows how wafer-electrodeionization can be used to recycle produced water back into the hydraulic fracturing process.

Exhibit A is a chart summarizing solution constituents at various points in the wastewater treatment system and method of the present inventive concept.

Exhibit B is a chart identifying frack/production water re-use standards (i.e. specific targets to achieve).

Exhibit C is a process overview and description of test results and conclusions reached.

Exhibit D is a report on performance of electrodialysis and electrodeionization on the removal of metal contaminants from step 1 wastewater treatment permeate.

### DETAILED DESCRIPTION

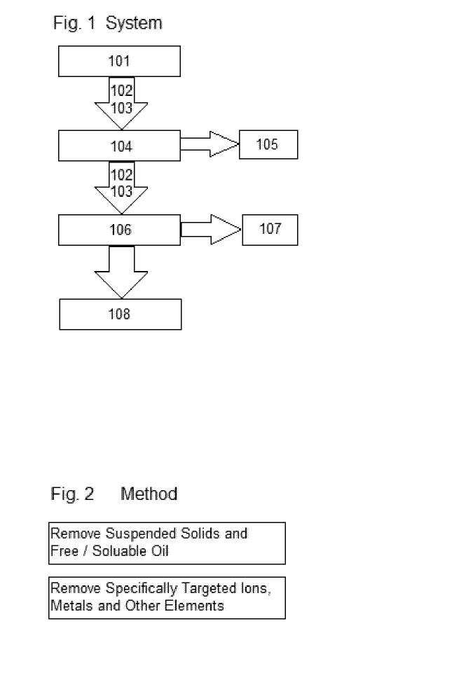

The system for treating wastewater includes two or more sub-systems for treating wastewater. An exemplary embodiment of a system of the present inventive concept is shown in FIG. 1. Referring to FIG. 1, the first sub-system 104 removes suspended solids and free/soluble oil. Wastewater is pumped from a feed or source 101 into the first sub-system 104 via a pump 102. The pump 102 is any known pump sufficient to transport wastewater from the feed or source 101 to the first sub-system within predetermined volume and pressure ranges. The feed or source 101 is one or more temporary or permanent storage tanks or direct feed via a pipe. The wastewater from the feed or source 101 is optionally heated or cooled 103 as required, depending on the preferred wastewater temperature range of the first sub-system 104 and the temperature of the wastewater at the feed or source 101. The heater/cooler 103 is any known fluid heater and/or cooler capable of heating and/or cooling water to within predetermined temperature ranges. In some embodiments, the predetermined temperature range is 4 degrees Celsius to 99 degrees Celsius. In some preferred embodiments, the predetermined temperature range is 15 to 50 degrees Celsius.

The first sub-system 104 comprises one or more wastewater treatment system that removes suspended solids and free/soluble oil from the wastewater. One example of a suspended solids wastewater treatment system that is employed as the first sub-system 104 in some embodiments is Dissolved Air Floatation (“DAF”) or Dissolved Gas Floatation (“DGF”). Another example of a suspended solids and free/soluble oil wastewater treatment system that is employed as the first sub-system 104 in some embodiments is American Petroleum Institute (“API”) oil-water separator. Another example is membrane filtration technologies, including micro, ultra and nano filtration processes. Another example is a clarifier. Another example is a reactor clarifier. Another example is an electro-precipitator. Another example of a suspended solids and free/soluble oil wastewater treatment system that is employed as the first sub-system 104 in some embodiments is Corrugated Plate Interceptor (“CPI”). Another example of a suspended solids and free/soluble oil wastewater treatment system that is employed as the first sub-system 104 in some embodiments is Intermittent Sand Filters (“ISF”).

In some embodiments, the first sub-system 104 comprises two or more wastewater treatment systems. For example, in some embodiments, the first sub-system 104 includes an API system and a DAF system. In other examples, the first sub-system 104 includes an API and/or CPI system and also a DAF, DGF and/or ISF system.

In some embodiments, the first sub-system 104 includes a biocide injection. For example, in some embodiments, chlorine dioxide is added to the wastewater output from the first sub-system 104. In some embodiments, the first sub-system 104 includes a sand filter. In some embodiments, the first sub-system 104 includes a bag filter. In some embodiments, the first sub-system 104 includes a cartridge filter.

The first sub-system 104 separates suspended solids and free/soluble oil from the wastewater feed or source 101 into one or more suspended solids storage container 105. The first sub-system 104 outputs wastewater that has been cleaned of various suspended solids. By way of example, the output from the first sub-system 104 includes the impurities identified in Table 1 (below) at or below the representative levels identified in Table 1 (below).

TABLE 1
Representative Levels of Various Impurities in Output from 104

| Total Dissolved Solids | | Barium | Calcium | Iron | Magnesium |
|---|---|---|---|---|---|
| [mg/L] | | [ppm] | [ppm] | [ppm] | [ppm] |
| 260,000 | | 4,700 | 30,000 | 55 | 10,000 |
| | | | | Total | Total |
| Sodium | Chloride | Sulfate | Oil &Gas | Alkalinity | Phosphorus |
| [ppm] | [ppm] | [ppm] | [ppm] | [ppm] | [ppm] |
| 45,000 | 148,000 | 1,300 | <50 mg/L | 26,000 | 100 |

The second sub-system 106 removes specifically targeted ions and elements to reduce them to desirable levels. Wastewater is pumped from the output from the first sub-system 104 into the second sub-system 106 via a pump 102. The pump 102 is any known pump sufficient to transport wastewater from the first subsystem 104 to the second sub-system 106 within predetermined volume and pressure ranges. The wastewater from the output of the first sub-system 104 is optionally heated or cooled 103 as required, depending on the preferred operational temperature range of the second sub-system 106 and the actual temperature of the wastewater from the output of the first sub-system 104. The heater/cooler 103 is any known fluid heater and/or cooler capable of heating and/or cooling water to within predetermined temperature ranges. In some embodiments, the predetermined temperature range is 4 degrees Celsius to 99 degrees Celsius. In some preferred embodiments, the predetermined temperature range is 15 to 50 degrees Celsius.

The second sub-system 106 comprises one or more wastewater treatment system that removes specifically targeted ions and elements. One example of a wastewater treatment system that is employed as the second sub-system 106 in some embodiments is Electro Dialysis (“ED”). Another example of a wastewater treatment system that is employed as the second sub-system 106 in some embodiments is Electro De-Ionization (“EDI”).

EDI uses ion exchange beads, in between ion exchange membranes, to change the transport properties of electrodialysis. This removes dilute ions more effectively than ED. Also, EDI can change the selectivity of the system. For example, many ion exchange resins are selective for divalents or monovalents. Thus, when using specific predetermined ion exchange resins, the addition of these ion exchange beads change the selectivity of the EDI, as compared to ED, to make it more selective for divalents over monovalents. Since the total cost of ion removal is based on how many ions are removed this makes the cost of removing divalents as compared to monovalents significantly less expensive.

The second sub-system 106 includes two opposing electrically charged membranes—one positive and the other negative. As wastewater flows through the second sub-system 106, ions and various metals and other elements are compelled toward one of the two electrically charged membranes and are separated from the water. The ions and various metals and other elements are separated into one or more storage container 107. The second sub-system 106 outputs reclaimed water 108 that has been cleaned of various ions and various metals and other elements. The second sub-system is set up to target specific ions, metals or other elements, depending on the composition of the initial wastewater feed or source 101 and/or the composition of the output from the first sub-system 104. The reclaimed water 108 from the second sub-system 106 includes the impurities identified in Table 2 (below) at or below the maximum levels identified in Table 2 (below). The levels of impurities represented in Table 2 (below) identify the maximum levels acceptable for reuse of the reclaimed water.

TABLE 2
Levels of Various Impurities for Reuse in Reclaimed Water 108

| Total Dissolved | | Barium | Calcium | Iron | Magnesium |
|---|---|---|---|---|---|
| Solids [mg-TDS/L] | | [ppm] | [ppm] | [ppm] | [ppm] |
| 100,000 | | <5 | <2,000 | <10 | <2,000 |
| | | | | Total | Total |
| Sodium | Chloride | Sulfate | Oil &Gas | Alkalinity | Phosphorus |
| [ppm] | [ppm] | [ppm] | [ppm] | [ppm] | [ppm] |
| <20,000 | <40,000 | <500 | <5 mg/L | 1,000 | <5 |

Nitrate [ppm]
<40

In some instances, the levels of various impurities fall below the detection limits of the equipment used to measure the levels of various impurities. In Table 3 (below), the minimum detection limits of the equipment for various impurities are identified.

TABLE 3
Levels of Detection Limits for Various
Impurities in Reclaimed Water 108

| Total Dissolved Solids | | Barium | Calcium | Iron | Magnesium |
|---|---|---|---|---|---|
| [mg-TDS/L] | | [ppm] | [ppm] | [ppm] | [ppm] |
| 100 | | <0.2 | <4 | <0.5 | <0.1 |
| | | | | Total | Total |
| Sodium | Chloride | Sulfate | Oil &Gas | Alkalinity | Phosphorus |
| [ppm] | [ppm] | [ppm] | [ppm] | [ppm] | [ppm] |
| <2 | <0.9 | 0.4 | <5 mg/L | 2 | 0.02 |

| Nitrate | Selenium | Mercury | Boron |
|---|---|---|---|
| [ppb] | [ppb] | [ppt] | [ppm] |
| <150 | <5 | <50 | <7.5 |

The method of treating wastewater includes removing suspended solids and free/soluble oil from a source of wastewater and removing specifically targeted ions and elements to predetermined maximum levels. An exemplary embodiment of a system of the present inventive concept is shown in FIG. 2. Referring to FIG. 2, suspended solids are removed from wastewater by any known method(s). In some embodiments, one way to remove suspended solids in wastewater to at or below the maximum levels discussed above is to use Dissolved Air Floatation (“DAF”) or Dissolved Gas Floatation (“DGF”). In some embodiments, another way to remove suspended solids is to use American Petroleum Institute (“API”) oil-water separator. In some embodiments, another way to remove suspended solids is to use membrane filtration technologies, including micro, ultra and nano filtration processes/systems. In some embodiments, another way to remove suspended solids is to use a clarifier. In some embodiments, another way to remove suspended solids is to use a reactor clarifier. In some embodiments, another way to remove suspended solids is to use an electro-precipitator.

Ions and various metals and other elements are specifically targeted for removal from the remaining wastewater) until the impurities identified in Table 2 (above) are at or below the maximum levels identified in Table 2 (above). In some embodiments, one way to remove specifically targeted ions and various metals and other elements is to use Electro Dialysis (“ED”). In some embodiments, another way to remove specifically targeted ions and various metals and other elements is to use Electro De-Ionization (“EDI”).

The removal of specifically targeted ions and various metals and other elements is accomplished via two opposing electrically charged membranes—one positive and the other negative. As wastewater flows between the opposing electrically charged membranes, ions and various metals and other elements are compelled toward one of the two electrically charged membranes and are separated from the water. The ions and various metals and other elements are separated out into one or more storage container. Reclaimed water that has been cleaned of various ions and various metals and other elements results. The process is set up to target specific ions, metals or other elements, depending on the composition of the initial wastewater feed or source and/or the composition of the output from the process of removing suspended solids. The reclaimed water includes the impurities identified in Table 2 (above) at or below the maximum levels identified in Table 2 (above).

Referring to Exhibit C, several wafer Electrodeionization and traditional electrodialysis experiments have been evaluated and compared to other separation techniques in terms of energy and economic costs. In EDI and ED energy costs are directly related to the amounts of ions that need to be removed. Power is applied to the systems which remove ions. According to the tables of Exhibit C, at low concentrations, power is better for ED and EDI and at high concentrations reverse osmosis (“RO”) or nanofiltration (“NF”) makes more economic sense.

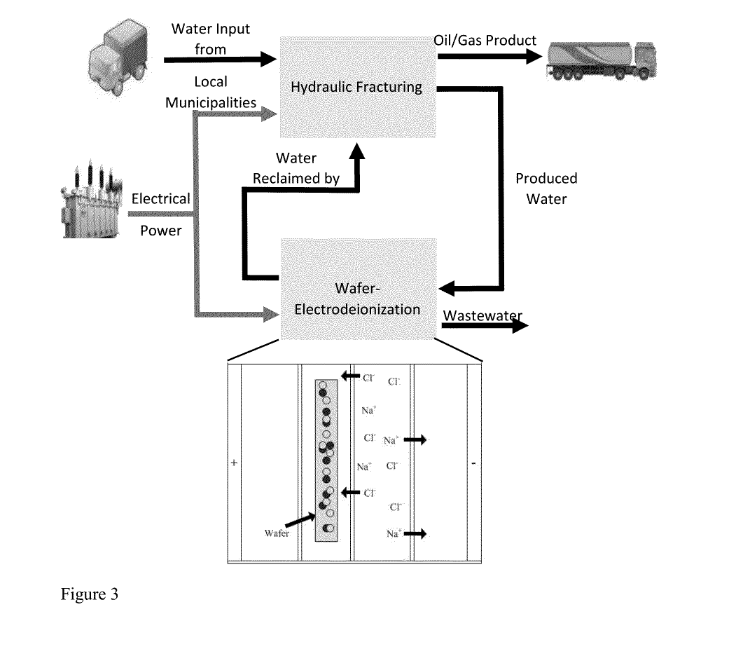

FIG. 3 shows how wafer-electrodeionization can be used to recycle produced water back into the hydraulic fracturing process. Ion exchange resins are inserted into the cells in the form of compressed wafers which are porous to allow water to flow through. Although sodium and chloride are shown in FIG. 3, any cation and anion can be separated from the water using this process.

Referring to Exhibit D, produced water was filtered through a first sub-system of the wastewater treatment system of the present inventive concept. Permeate was collected for testing with the inventive wafer-EDI technology. The permeate was tested with traditional electrodialysis and wafer-EDI to compare the performance of each method of separation. The key finding from this study is the targeting of divalent ions with wafer-EDI. This allows selective separation of calcium and other heavy cations, resulting in shorter separation times and lower power consumption.

The inventive concept includes the adaptation of wafer electrodeionization techniques for application in water recovery, specifically in high salt solutions. Most wafer electrodeionization is done to remove ions from solutions containing low ion concentrations. However, this is the first time that high salt solutions have been considered. Adaptation of electrodeionization techniques for high salt removal is both novel and revolutionary in that it broadens the scope of this technology to applications previously unconsidered. The modification to EDI contemplated by the inventive concept includes adapting wafers for selective ion removal. Thus, these wafers include combinations of ion exchange beads that are specifically designed for divalent over monovalent selectivity.

In refinery and hydraulic fracturing operations selective separation of specifically targeted ions is quite important. In hydraulic fracturing, calcium concentration needs to be at less than 2,000 ppm; sodium needs to be at less than 30,000 ppm. Thus, selective separation of ions to achieve specific levels of maximum concentration is important.

The inventive concept includes a wafer electrodeionization module for high salt removal for use, for example, in the hydraulic fracturing industry. Typical fracking solutions contain high concentrations of sodium, calcium, and other contaminant metals. Requirements for re-use of this process water is complete removal of divalent ions and reduction of sodium levels below 50,000 ppm. The inventive wafer electrodeionization technology is capable of selective separation of divalent ions and further purifying these solutions to ion levels below these requirements. From this technology, the large water requirements for fracking will be reduced, resulting in resource and cost savings for the industry. This wafer EDI technology allows for separations of ions from a process stream. The wafers show specific divalent over monovalent selectivity.

Developments in this invention will include process optimization by creation of optimum wafer for this application. Variables to optimize include wafer chemistry, thickness, porosity, and module geometry.

### EXAMPLES

In one embodiment, the wafers used in the EDI module had a thickness in the range of 0.5 to 1.5 mm (depending on stack used for testing). The wafers also had a porosity in the range of 38% to 40%. The resin ratio was 50% cation resin and 50% anion resin. The wafers were sized and shaped to fit within the spacer design of a specific stack.

Wafer chemistry refers to the specific recipe that is used to form the wafers. It describes the anion and cation resins used, the polymer used as a binding substrate, and the filler used to create wafer porosity. Additionally, it defines the ratio that these materials are mixed in as well as the heating temperature, pressure applied, and cook time. In one embodiment, the wafer chemistry included:

TABLE 4
Exemplary EDI wafer chemistry

Cation resin: Amberlite IRA-120 plus
Anion resin: Amberlite IRA-400
Polymer: Polyethylene
Filler: Sucrose
Temperature: 237 F.
Pressure: 10,000 psi
Time: 90 minutes

In some embodiments, the anion resin concentration within the wafers is increased (compared to the above-described example). In some embodiments, the amount of polymer is varied such that the wafer is fully formed without covering the resins. The amount of polymer is sufficient to make the wafer robust, yet not so much as to coat the resins and reduce the active surface area. Wafers of the present inventive concept are included within the following ranges:

TABLE 5
Exemplary EDI wafer chemistry

Thickness: 0.1-2 mm
Porosity: 25-60%
Resin ration: 10:90 cation/anion to 90:10 cation/anion
Temperature: 190-250 F.
Pressure: 1,000-12,000 psi
Time: 30-120 minutes

In one exemplary embodiment, a selective separation specifically targeted the separation of calcium from sodium in a hydraulic fracturing solution. Ion exchange beads were at a ratio of cationic (where Amerberlite IRA-400 was used in this specific example), anionic (where Amerberlite IR-120 was used in this specific example), sugar, and polyethylene of 23:23:15:10, respectively, and made into an ion exchange wafer. In this particular arrangement the Amberlite IR-120 is selective towards calcium over sodium. A hydraulic fracturing wastewater solution was run through the wafer and across selective ion exchange membranes as described herein. In this particular exemplary embodiment, the membrane area was 2 m² total and the total volume was 4 L on the concentrate and dilute side. The results of the experiment are in Table 6.

TABLE 6
Experimental Results

| | Total Salt | Sodium | Calcium |
|---|---|---|---|
| | Concentration (ppm) | (Na) (ppm) | (Ca) (ppm) |
| Initial | 50,000 | 32,000 | 10,000 |
| Final | 15,000 | 10,000 | 2,000 |
| Waste | 200,000 | | |

As shown, the calcium is reduced 80% while the sodium is only reduced 69% even though the sodium is at a much higher concentration. This results in a big energy savings. This particular embodiment shows the selectiveness of this system with cationic ions.

In another exemplary embodiment, the inventive concept is selective of anionic ions. In commercial refineries anions such as selenium or nitrate are quite important to remove. The level that is required is often less than a commercial reverse osmosis system can produce. Thus, an experiment was performed with simulated RO permeate that contained 200 ppm NaCl and 40 ppm NaNO₃ using the same wafer from the exemplary embodiment described immediately above. In this case, the Amerberlite IRA-400 is the important component of the selectivity as it gives nitrate over calcium selectivity. At the end of a 3 hour experiment, 90% of the nitrate was removed while only 50% of the chloride was removed. This shows that a wafer can be made to selectively remove a component of interest (nitrate in this example) from a non-hazardous component (chloride in this example).

The selectivity observed is much higher than the beads alone would be capable of separating. This is because the pH conditions inside of the wafer are unique to the EDI system and allow for this increased selectivity. One skilled in the art would recognize that use of different resins will achieve different selectivity of specifically targeted ions. Some examples of different resins tested by the inventors that show ion selectivity that can be used in refinery applications and fracking applications is shown in Table 7.

TABLE 7
Selected Ion Exchange Resins

| Ion Exchange | | |
|---|---|---|
| resin | Producer | Properties |
| Amberlite | Aldrich/Rohm | Strongly basic |
| IRA-400 (Cl) | and Haas | |
| Dowex | Sigma- | Strongly basic, 200-400 mesh |
| 1X8 chloride | Aldrich/Dow | |
| form | | |
| Amberlyst A-21 | Aldrich/Rohm | Ion exchange resin weakly basic, |
| | and Haas | macroreticular resin with alkyl |
| | | amine functionality |
| Anionic resin | Ameridia | Anionic resin |
| AM201302 | | |
| Amberlite | Sigma/Rohm | Nonionic polymer adsorbent 725 |
| XAD-4 | and Haas | m2/g, 40 A, 20-60 mesh |
| Amberlite | Sigma | Nonionic polymer adsorbent 800 |
| XAD-16 | | m2/g, 100 A, 20-60 mesh |
| Amberlite | Rohm and | Modified quaternary amine |
| FPA55 | Haas | acrylic polymer. Cl ion form. |

Another application of the wafer enhanced EDI system is that ions can be removed down to extremely dilute levels (Arora et al. 2007) often less than 1 ppb. Although this has been demonstrated on fermentation broths it has never been shown in refinery applications. Thus, the EDI is both selective and allows for extremely low concentration separation necessary in refinery and fracking applications.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

While the present general inventive concept has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

It is also to be understood that the following claims are intended to cover all of the generic and specific features of the invention herein described, and all statements of the scope of the invention which, as a matter of language, might be said to fall there between. Hence, the proper scope of the present general inventive concept should be determined only by the broadest interpretation of the appended claims so as to encompass all such modifications as well as all relationships equivalent to those illustrated in the drawings and described in the specification. It should also be understood that multiple combinations of dependent claims are also cumulatively and independently disclosed.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed is:

1. A wastewater treatment system comprising:
a first sub-system that removes suspended solids and free/soluble oil from wastewater;
a second sub-system that removes targeted ions or elements from wastewater; and
a pump to move wastewater through the first or second sub-system.

2. The wastewater treatment system of claim 1, wherein the first sub-system is one or more of Dissolved Air Floatation (“DAF”), Dissolved Gas Floatation (“DGF”), American Petroleum Institute (“API”) oil-water separator, membrane filtration technologies, clarifier, reactor clarifier, electro-precipitator, Corrugated Plate Interceptor (“CPI”), or Intermittent Sand Filters (“ISF”).

3. The wastewater treatment system of claim 1, wherein the first sub-system includes one or more of the following: a biocide injection, addition of chlorine dioxide, a sand filter, a bag filter, or a cartridge filter.

4. The wastewater treatment system of claim 1 wherein the second sub-system is Electro Dialysis (“ED”).

5. The wastewater treatment system of claim 1 wherein the second sub-system is Electro De-Ionization (“EDI”).

6. The wastewater treatment system of claim 1, wherein the second sub-system includes an output wastewater feed that includes the following impurities at or less than the following level:
Total Dissolved Solids−100,000 mg/L.

7. The wastewater treatment system of claim 1, wherein the second sub-system includes an output wastewater feed that includes the following impurities at or less than the following level:
Total Dissolved Solids—40,000 mg/L.

8. The wastewater treatment system of claim 1, wherein the second sub-system includes an output wastewater feed that includes the following impurities at or less than the following level:
Barium—5 ppm.

9. The wastewater treatment system of claim 1, wherein the second sub-system includes an output wastewater feed that includes the following impurities at or less than the following level:
Barium—0.2 ppm.

10. The wastewater treatment system of claim 1, wherein the second sub-system includes an output wastewater feed that includes the following impurities at or less than the following level:
Calcium—2,000 ppm.

11. The wastewater treatment system of claim 1, wherein the second sub-system includes an output wastewater feed that includes the following impurities at or less than the following level:
Calcium—4 ppm.

12. The wastewater treatment system of claim 1, wherein the second sub-system includes an output wastewater feed that includes the following impurities at or less than the following level:
Iron—10 ppm.

13. The wastewater treatment system of claim 1, wherein the second sub-system includes an output wastewater feed that includes the following impurities at or less than the following level:
Iron—0.5 ppm.

14. The wastewater treatment system of claim 1, wherein the second sub-system includes an output wastewater feed that includes the following impurities at or less than the following level:
Potassium—500 ppm.

15. The wastewater treatment system of claim 1, wherein the second sub-system includes an output wastewater feed that includes the following impurities at or less than the following level:
Magnesium—2,000.

16. The wastewater treatment system of claim 1, wherein the second sub-system includes an output wastewater feed that includes the following impurities at or less than the following level:
Magnesium—0.1 ppm.

17. The wastewater treatment system of claim 1, wherein the second sub-system includes an output wastewater feed that includes the following impurities at or less than the following level:
Sodium—20,000 ppm.

18. The wastewater treatment system of claim 1, wherein the second sub-system includes an output wastewater feed that includes the following impurities at or less than the following level:
Chloride—40,000 ppm.

19. The wastewater treatment system of claim 1, wherein the second sub-system includes an output wastewater feed that includes the following impurities at or less than the following level:
Chloride—20,000 ppm.

20. The wastewater treatment system of claim 1, wherein the second sub-system includes an output wastewater feed that includes the following impurities at or less than the following level:
Sulfate—500 ppm.

21. The wastewater treatment system of claim 1, wherein the second sub-system includes an output wastewater feed that includes the following impurities at or less than the following level:
Sulfate—0.4 ppm.

22. The wastewater treatment system of claim 1, wherein the second sub-system includes an output wastewater feed that includes the following impurities at or less than the following level:
Oil and Gas—5 mg/L.

23. The wastewater treatment system of claim 1, wherein the second sub-system includes an output wastewater feed that includes the following impurities at or less than the following level:
Total Alkalinity—1,000 ppm.

24. The wastewater treatment system of claim 1, wherein the second sub-system includes an output wastewater feed that includes the following impurities at or less than the following level:
Total Phosphorus—5 ppm.

25. The wastewater treatment system of claim 1, wherein the second sub-system includes an output wastewater feed that includes the following impurities at or less than the following level:
Total Phosphorus—0.02 ppm.

26. A wastewater treatment system comprising:
an EDI system comprising one or more ion exchange wafer configured to selectively remove a specifically targeted ion to at or below a predetermined maximum level of concentration.

27. The wastewater treatment system of claim 26, wherein the specifically targeted ion is calcium.

28. The wastewater treatment system of claim 27, wherein the predetermined maximum level of concentration is 2,000 ppm.

29. The wastewater treatment system of claim 27, wherein the predetermined maximum level of concentration is at or below 4 ppm.

30. The wastewater treatment system of claim 26, wherein the specifically targeted ion is sodium.

31. The wastewater treatment system of claim 30, wherein the predetermined maximum level of concentration is 20,000 ppm.

32. The wastewater treatment system of claim 30, wherein the predetermined maximum level of concentration is 2 ppm.

33. The wastewater treatment system of claim 26, wherein the specifically targeted ion is nitrate.

34. The wastewater treatment system of claim 33, wherein the predetermined maximum level of concentration is 40 ppm.

35. The wastewater treatment system of claim 33, wherein the predetermined maximum level of concentration is 150 ppb.

36. The wastewater treatment system of claim 26, wherein the specifically targeted ion is selenium.

37. The wastewater treatment system of claim 36, wherein the predetermined maximum level of concentration is 5 ppb.

38. The wastewater treatment system of claim 26, wherein the specifically targeted ion is chloride.

39. The wastewater treatment system of claim 38, wherein the predetermined maximum level of concentration is 40,000 ppm.

40. The wastewater treatment system of claim 38, wherein the predetermined maximum level of concentration is 900 ppb.

41. The wastewater treatment system of claim 26, wherein the specifically targeted ion is mercury.

42. The wastewater treatment system of claim 41, wherein the predetermined maximum level of concentration is 50 ppt.

43. The wastewater treatment system of claim 26, wherein the specifically targeted ion is boron.

44. The wastewater treatment system of claim 43, wherein the predetermined maximum level of concentration is 7.5 ppm.

45. A method of wastewater treatment comprising:
removing suspended solids and free/soluble oil; and
removing targeted ions or elements.

46. A wastewater treatment method comprising:
selectively removing a specifically targeted ion to a predetermined maximum level of concentration with an EDI system that comprises one or more ion exchange wafer configured to selectively remove the specifically targeted ion to the predetermined maximum level of concentration.
